(19) United States
(12) Patent Application Publication
(10) Pub. No.: US 2025/0239639 A1
(43) Pub. Date: Jul. 24, 2025

(54) FUEL CELL SYSTEM

(71) Applicant: Bruno SANGLE-FERRIERE, PARIS (FR)

(72) Inventor: Bruno SANGLE-FERRIERE, PARIS (FR)

(21) Appl. No.: 18/699,398

(22) PCT Filed: Oct. 3, 2022
(86) PCT No.: PCT/EP2022/077460

§ 371 Date: Apr. 8, 2024

(30) Foreign Application Priority Data
Oct. 7, 2021 (FR) 2110637

(51) Int. Cl. H01M 8/18; H01M 4/90; H01M 4/92; H01M 8/0215; H01M 8/1253; H01M 8/126; H01M 8/22

(52) U.S. Cl. CPC H01M 8/182; H01M 4/9025; H01M 4/92; H01M 8/0215; H01M 8/1253; H01M 8/126; H01M 8/22

(57) ABSTRACT

Electrochemical reaction fuel cell system, comprising:
a cathode (8), an anode (1),
one at least of the anode and of the cathode comprising at least one metal, one metal hydroxide or one metal oxide in the molten state,
   a solid electrolyte (7), placed between the cathode and the anode,
   at least one regenerator (4) for regenerating, starting from one at least of the oxidation-reduction reaction products which is recovered at at least one of the anode and of the cathode, by a reaction, at least one of the products constituting at least one of the anode or of the cathode or the fuel or oxidizer consumed at at least one of the anode or of the cathode,
one of the regeneration products being reintroduced into the system as electrode made of liquid metal or liquid metal oxide or in the form of fuel or oxidizer, one of the reactions making possible said regeneration or making possible the regeneration of one of the reactants of the oxidation-reduction reaction being endothermic.

The present invention relates to the field of the generation of electricity from heat, by the use of electrochemical cells having solid electrolytes.

### TECHNICAL FIELD

To date, the conversion of heat into electrical energy is most often done by turbines, internal combustion engines or Rankine cycles. These conversion methods have limited efficiencies and lead to not insignificant energy losses, which are most often dissipated in rivers, in the air or in the sea. Moreover, on the one hand, these low yields, of the order of 30% to 60%, do not make it possible to use certain new energy sources, in particular nuclear fusion caused by the electrical acceleration of ions on targets, which require large amounts of electrical energy to function; on the other hand, these techniques are accompanied by the production of heat at the time of the conversion into electricity.

Conventional electric batteries make it possible to transform chemical energy into electrical energy; however, their conventional design, made of solid electrodes which waste away and have to be discarded or which it is necessary to remove in order to replace them, makes it difficult to use them for industrial-scale electricity production or even for feeding energy to a vehicle, in particular if these batteries are not designed to be rechargeable.

Moreover, the use of solid electrodes with a coating generally leads to the formation of dendrites adjoining the electrodes, composed of the product of the oxidation-reduction reaction occurring during the production of energy; these coatings and dendrites cause significant energy dissipations by the Joule effect and degrade the performance qualities of the batteries.

Liquid metal batteries make it possible to overcome the problem of the formation of dendrites in particular, and their development dates back to the 1960s, when the first batteries having molten electrodes of Na-Sn type were proposed.

The patent U.S. Pat. No. 3,245,836 thus describes a cell, the electrodes of which consist of molten sodium and molten tin, separated by a liquid NaCl electrolyte impregnating a porous separator. Metallic sodium is oxidized at the negative electrode and sodium ions are reduced at the positive electrode, where metallic sodium mixes with tin.

A regenerator makes it possible to separate the tin from the sodium by heat treatment, and the pure metals can be reinjected into the cell to compensate for the consumption of sodium at the negative electrode and the contamination of the tin by sodium at the positive electrode.

However, the liquid electrolyte of the cell and also the presence of solid separators between each of the electrodes and the electrolyte makes the cell very bulky and less efficient.

The paper Next-Generation Liquid Metal Batteries Based on the Chemistry of Fusible Alloys, ACS Cent. Sci., 2020, 6, 1355-1366, describes some recent avenues for the development of liquid metal batteries.

WO2017/201228 discloses a SOFC (Solid Oxide Fuel Cell) using hydrocarbons as fuel or oxidizer.

US2018/3745141 and US2015/311545 disclose a system comprising two SOFCs.

WO2008/138923 discloses a fuel cell using a solid carbon-based substrate.

WO2008/044083 discloses a galvanic cell using a liquid electrolyte.

US 2011014526 discloses a fuel cell using a fuel or oxidizer comprising carbon.

WO2014/201274 discloses electrodes using metal for gas separation and generation.

However, to the knowledge of the inventor, few solutions exist proposing methods of regeneration of electrodes and/or fuels by the implementation of endothermic chemical reactions.

Despite the developments made, there still remains a need to benefit from a system comprising a compact and high-performance cell which makes it possible to produce electricity with high efficiency from diverse heat sources.

### SUMMARY OF THE INVENTION

The invention is targeted at meeting this need, and achieves this by proposing a fuel cell system, comprising:
a cathode,
an anode,

one at least of the anode and of the cathode comprising at least one metal, one metal hydroxide or one metal oxide in the molten state,
a solid electrolyte, placed between the cathode and the anode,
at least one regenerator for regenerating, by a reaction, at least one of the products constituting at least one of the anode or of the cathode or the fuel or oxidizer consumed at at least one of the anode or of the cathode.

The regenerator can regenerate said products from at least one of the products of at least one of the oxidation or reduction reactions occurring at the anode or the cathode, made of metal, metal alloy, or metal oxide, produced at the anode or the cathode during the production of electricity by the cell.

By virtue of the invention, there is available a means for the production of electricity which makes it possible in particular to feed electricity to an energy production installation which is electricity-intensive and capable of releasing a large amount of heat at high temperature, such as an installation for the production of energy by controlled nuclear fusion. The cell according to the invention can exhibit high efficiency, while being capable of remaining in a relatively compact volume.

Within the meaning of the invention, the term “cell system” denotes the system which makes possible the production of electricity and all or part of the regeneration, continuously or intermittently.

The regeneration can regenerate at least one of the products constituting at least one of the anode or of the cathode or the fuel or oxidizer consumed at at least one of the anode or of the cathode by an endothermic reaction. The regenerated fuel or oxidizer can be different from the molecular oxygen.

This reaction thus requires only a supply of heat but no supply of reactants apart, possibly, from molecular oxygen. It does not require fuel other than products recovered from at least one of the oxidation or reduction reactions occurring at the anode or at the cathode. In particular, the regeneration does not require the use of fuel external to the system.

Preferably, the electrodes, i.e., the anode and the cathode, have the form of compartments. The regenerator can also be in the form of a compartment separated from the compartments of the electrodes. The regeneration product(s) can be reinjected into the electrodes via pipes external to the compartments of the electrodes.

### ACCOUNT OF THE INVENTION

### Molten Metal

The anode preferably comprises a metal in the molten state. The cathode can comprise a metal, a metal hydroxide or a metal oxide in the molten state.

The metal in the molten state can be the fuel or the oxidizer.

The metal can be chosen from the following list, which is not limiting: zinc, lithium, magnesium, aluminum, lead, sodium, cesium, rubidium, copper, tin and their alloys. Preferably, the metal is zinc.

The cell can thus be configured to produce or consume, at the anode or at the cathode, a metal oxide or a metal hydroxide chosen from the following list, which is not limiting: zinc oxide (ZnO), lithium oxide (Li₂O), magnesium oxide (MgO), alumina (Al₂O₃), lead oxide

(PbO), lead dioxide (PbO₂), sodium oxide (Na₂O), cesium oxide (Cs₂O), rubidium oxide (Rb₂O), copper (II) oxide (CuO), copper (I) oxide (Cu₂O), copper (III) oxide (Cu₂O₃), manganese dioxide (MnO₂), sodium hydroxide (NaOH), manganese hydroxide (MnOOH), zinc hydroxide (Zn(OH)₂), and their mixtures.

In particular, the cell can be arranged in order to consume manganese dioxide at the cathode.

### Solid Electrolyte

The solid electrolyte can be chosen from:
(i) an O²⁻ion exchange membrane, or
(ii) a solid acid, or
(iii) an anion exchange membrane or
(iv) a metal ion exchange membrane.

The O²⁻ion exchange membrane can be a solid oxide.

The cell system can comprise a separating membrane between the anode and the electrolyte, the separating membrane being an 02-ion exchanger. The separating membrane can comprise ceria.

### Solid Oxide Electrolyte

The cell can be a solid oxide cell, known as SOFC. The electrolyte can be in the form of a solid oxide.

The fuel cell system can be configured to operate at temperatures of 280° C. and 1100° C.

The solid oxide can be chosen from the following list, which is not limiting:
yttria-stabilized zirconia, referred to as YSZ,
scandia-stabilized zirconia, referred to as ScSZ,
ceria-salt ceramic composites, referred to as CSCs,
erbia-cation-stabilized bismuth, referred to as ERB,
gadolinium-doped ceria, referred to as GDC,
samaria-doped ceria, referred to as SDC,
ceria/bismuth-oxide bilayered electrolyte, referred to as GDC-ESB, formed of a layer of ceria-doped gadolinium and of a layer of erbia-stabilized bismuth oxide,
strontium iron oxide SrFeO₂,
and their mixtures.

The last four solid oxides mentioned above can be used for operating temperatures of the cell for example of between 600° and 800°, which can be very particularly of use for metals having a lower melting point, and the last electrolyte can be used at 500° C.

The solid oxide can be composed of iron and of strontium, with the formula SrFeO₂, which allows O²⁻ions to pass through from 280° C.

In the case of a solid oxide cell, the reaction at the anode is:

M+O²->MO+2 e⁻

and the reaction at the cathode is:

½O₂+2 e⁻->2 O²⁻

where M is the metal, for example zinc Zn.

The O²⁻ ions can originate from the separation of molecular oxygen by supplying electrons to the electrode of the cell which absorbs molecular oxygen. The molecular oxygen can originate from the air or from a zeolite concentrator which has extracted said molecular oxygen from the air.

The electrode which absorbs the oxygen, in particular the cathode, can comprise lanthanum strontium manganite or lanthanum strontium cobalt ferrite. The lanthanum strontium manganite can be protected from an electrolyte containing yttria-stabilized zirconia, referred to as YSZ, by a film of gadolinium-doped ceria, referred to as GDC. Such a film can have a thickness of approximately 0.5 μm.

The metal oxide MO, for example zinc oxide ZnO, is then replaced by molten metal, being discharged with nonoxidized liquid metal. The metal oxide is subsequently, preferably, separated from the molten metal by settling or in a centrifuge, from the center of which the metal oxide is extracted, if it is less dense than the metal itself, and the metal of which is also extracted from the other end.

The metal oxide is preferably regenerated to give metal by chemical means and supply of heat, and the oxygen possibly produced can be reused to feed the cathode.

### Solid Acid Cell (SAFC)

In an alternative embodiment of the invention, the electrolyte is a solid acid, such as, for example, cesium dihydrogen phosphate (CsH₂PO₄). The cathode can be composed of manganese dioxide (MnO₂) advantageously mixed with carbon molecules in order to increase the electrical conductivity thereof.

Water is brought at high pressure to the anode so that the pressure of the electrolyte is kept high, for example 3 GPa or 30 atmospheres, to prevent its decomposition at the temperature of the molten metal of the anode, for example 440° C. for zinc, or else at 240° C. for lithium, under a partial water vapor pressure preferably of greater than 0.1 atmosphere, for example 1 atmosphere.

The reaction at the anode is then:

M+H₂O−->MOH+H⁺+2 e⁻

and the reaction at the cathode is:

MnO₂(s)+H⁺+e⁻→MnO(OH)(s)

where M is the metal, for example lithium Li, and MOH is its hydroxide, for example LiOH, or also, for example, M is zinc and MOH is its hydroxide Zn (OH)₂.

The metal hydroxide MOH, for example lithium hydroxide LiOH, is then replaced by molten metal, being discharged with nonoxidized liquid metal. The metal oxide is subsequently, preferably, separated from the molten metal by settling or in a centrifuge, from the center of which the metal hydroxide is extracted, if it is less dense than the metal itself, and the metal of which is also extracted from the other end.

The metal hydroxide is preferably regenerated to give metal by chemical means and supply of heat and possibly of electricity, for example by chemical reactions described below, it being possible for a portion of the electricity produced by the cell to be used in one of the reactions used for the regeneration of the metal hydroxide to give metal.

The manganese dioxide cathode which is transformed into manganite can be recycled by being melted, for example, at 550° C., the manganite being then extracted by filtration, sedimentation or centrifugation, then the manganese oxide can be regenerated, by oxidation of manganite MnO (OH) to give manganese oxide MnO2 at approximately 300° C.

### Anion Exchange Electrolyte

In an alternative embodiment of the invention, the electrolyte is a membrane which conducts the OH⁻ anion and is, for example, hexamethyl trimethylammonium-functionalized Diels-Alder polyphenylene, referred to as HTMA-DAPP, or low density polyethylene-benzyltrimethylammonium, referred to as LDPE-BTMA.

For an anion exchange cell, the cathode can be manganese dioxide, preferably including carbon nanoparticles in order to increase its conductivity, and the anode can be a metal M liquid at a temperature withstood by the electrolyte, such as, for example, sodium at 100° C. As water is being introduced at the cathode, the electrochemical reactions are:
at the cathode:

MnO₂+H₂O+e⁻ ->MnOOH+OH⁻
and at the anode:

M+OH⁻->MOH+e⁻.

The metal hydroxide MOH, for example zinc hydroxide Zn (OH)₂, is then replaced by molten metal, being discharged with nonoxidized liquid metal. The metal hydroxide is subsequently, preferably, separated from the molten metal by settling or in a centrifuge, from the center of which the metal hydroxide is extracted, if it is less dense than the metal itself, and the metal of which is also extracted from the other end.

The water circulating under pressure in and around the manganese dioxide cathode can advantageously be filtered to extract the manganite therefrom. The manganite dioxide cathode, which can also contain manganite, can circulate around an endless screw and be conveyed into a vessel or a reactor to be recycled there by being melted, for example at 550°° C., the manganite then possibly being extracted by filtration, sedimentation or centrifugation, it being possible for the manganese oxide to be regenerated by oxidation of the manganite MnO(OH) to give manganese oxide MnO₂ at approximately 300° C., according to the reaction:

MnO(OH)+½O₂->MnO₂+½H₂O

The regeneration of the anode can be accomplished in the same way as for the solid acid cells.

### Metal Ion Exchange Membrane Cell

The solid electrolyte can be a conductor of metal ions, such as, for example, Na₃PS₄, β-alumina, solid-state polymer electrolytes, referred to as SPEs, in particular including NaClO₄ and TiO₂ nanoparticles, sodium superionic conductors, referred to as NASICONs, in particular Na₃Zr₂Si₂PO₁₂ (NZSP), Na₁₁Sn₂PS₁₂ or Na_{2.88}Sb_{0.88}W_{0.12}S₄. β-Alumina is preferably complexed with the metal ion, for example one of the sodium Na⁺, potassium K⁺, lithium Li⁺, silver Ag⁺, hydride H⁺, lead Pb²⁺, strontium, Sr²⁺ or barium Ba²⁺ ions, which it has to transport as electrolyte.

The metal ionized at one electrode passes through the membrane which is permeable to it to join the metal of the other electrode and to combine with it to form an alloy.

The two metals can, for example, be tin and sodium, the cell preferably operating at a temperature where the two metals are liquid, for example 240° C. for the tin/sodium cell.

In an alternative form, the two metals can, for example, be tin and potassium, operating for example at 240° C. with an electrolyte, for example made of β-alumina. The alloys can be heated to a temperature where they are dissociated into metals, for example 870° C., at which temperature the tin is liquid but the potassium is gaseous.

### Reserve

The metal, the metal hydroxide or the metal oxide consumed at the anode and/or at the cathode, at one at least of the electrodes, indeed even at each of the electrodes, can advantageously originate from at least one reserve, in particular from a reserve of this metal or oxide.

One of said reserves can be in solid form, in particular in the form of beads, said beads being melted in order to be introduced in the liquid state at said electrode.

The metal, metal hydroxide or oxide can be present within this reserve in various forms, in particular solid forms, for example in the form of a powder, granules, beads or ingots; for example, the metal or oxide is in the form of beads, for example 1 mm in diameter. The intermittent injection of a rare gas into a pipe of liquid materials, such as molten metal, a metal oxide or a metal hydroxide, melted at a temperature close to their solidification, can for example cut these materials into beads. The metal present in the reserve is preferably melted before being introduced at the electrode which consumes it.

### Regenerator

The term “regenerator” denotes the system which makes it possible to recover one at least of the oxidation-reduction reaction products, possibly mixed with the reactant product, and to treat it in order to create one or more chemical entities which can be used as electrodes or as fuel or oxidizer introduced at the electrodes.

The or one of the products of the chemical reaction at at least one of the electrodes can be separated from the reacting product. The separation can be carried out by static or nonstatic settling, or by centrifugation.

The regenerator can employ a physical separation.

### Physical Separation

In order to make possible continuous operation over a long period of time, the or one of the products of the chemical reaction at at least one of the electrodes is separated from the reacting product.

This separation is preferably carried out physically, in particular by settling or by centrifugation.

The regenerator can thus comprise a centrifuge for centrifuging a mixture originating from the electrode. The metal oxide, if it is less dense than the metal, can thus be extracted from the center of the centrifuge, and the metal freed from the oxide is recovered at the periphery.

Several centrifugation stages can be provided, if necessary.

At least one of the products of the chemical reaction at at least one of the electrodes, which products are mixed or separated, can be stored in a tank.

The regenerator can comprise a centrifuge for extracting the metal oxide from the molten metal of the anode. Alternatively, the regenerator can operate by settling, in particular when two entities are not miscible and have different densities, for example when one is liquid and the other a solid floating on the liquid.

Said product stored in a tank can be cooled beforehand, in particular countercurrentwise to the product introduced and used for one of the two electrodes, then and preferably cut into round beads before having solidified.

Manganite MnOOH extracted from water can be stored in the form of a powder.

### Chemical Regeneration

In addition to a physical separation, or as replacement for a physical separation, the process of regeneration of at least one of the products consumed at one at least of the electrodes can comprise a chemical reaction.

One of the reactions making possible said regeneration or making possible the regeneration of one of the reactants is endothermic. It can be a reduction of an oxide in the presence of hydrogen or of carbon, with supply of heat. Alternatively, this reaction may not require hydrogen or carbon. A reduction of the oxide without supply of hydrogen or of carbon can also produce molecular oxygen. Preferably, in the case where the regeneration process comprises several reactions, one at least of the reactions is endothermic.

One of the regeneration products can be reintroduced into the system as electrode made of metal or metal oxides, or also in the form of fuel or oxidizer, in particular if molecular hydrogen or molecular oxygen is concerned.

For example, when zinc oxide has to be regenerated, it can be transformed into zinc metal by hydrogenation at 1000° C. approximately, according to the reaction:

ZnO+H₂->Zn+H₂O.

The reaction is endothermic with ZnO and H₂ recovered from the electrodes or products of another reaction belonging to the regeneration process.

When magnesium oxide has to be regenerated to give magnesium, the Pidgeon reduction can be employed:

MgO+C->Mg+CO,

it being possible for the carbon monoxide to be converted into carbon by the exothermic Boudouard reaction: 2 CO->CO₂₊C at high temperatures, for example 650° C., it being possible for the carbon dioxide to be removed from the carbon monoxide-carbon dioxide mixture for example by cycles of absorption of the carbon dioxide over lithium orthosilicate (Li₄SiO₄), then desorption at low pressure, for example 0.04 atmospheres, of the carbon dioxide in a carbon dioxide pipeline; then the carbon dioxide is converted into carbon monoxide and molecular oxygen by high-temperature electrolysis.

The reaction is endothermic with MgO and C recovered from the electrodes or products of another reaction belonging to the regeneration process.

One of the reactions can be the oxidation of manganite (MnOOH) to give manganese oxide (MnO₂):

MnOOH+½O₂->MnO₂+1/2H₂O at 300° C.

The reaction is endothermic with MgOOH and O₂ recovered from the electrodes or originating from the air.

One of the reactions can be the reduction of zinc oxide to give zinc:

ZnO->Zn+½O₂.

The reaction is endothermic with ZnO recovered from the electrodes.

One of the reactions can be the transformation of zinc hydroxide to give zinc oxide or the transformation of lithium hydroxide to give lithium oxide:

Zn(OH)₂->ZnO+H₂O,

2 LiOH->Li₂O+H₂O, for example at more than 550° C. under 120 mmHg or 0.15 atmosphere of water vapor pressure.

One of the reactions can be the reduction of zinc oxide to give zinc, consuming molecular hydrogen:

ZnO+H₂->Zn+H₂O.

One of the reactions can be the reduction of cesium oxide by reaction with magnesium: Cs₂O+Mg->2 Cs+MgO, the magnesium oxide being regenerated for example as described above.

One of the reactions can be the reduction of lithium oxide by reaction with magnesium Li₂O+Mg->2 Li+MgO, the magnesium oxide being regenerated to give magnesium for example as described above.

One of the reactions can be the reduction of rubidium oxide by reaction with magnesium Rb₂O+Mg->2 Rb+MgO, the magnesium oxide being regenerated for example as described above.

One of the reactions can be the reduction of zinc oxide with carbon monoxide:

ZnO+CO->Zn+CO₂

The reaction is endothermic with ZnO and CO recovered from the electrodes or from another reaction belonging to the regeneration process.

One of the reactions can be the regeneration of sodium hydroxide to give sodium, and which can be from the following reactions:

4 Fe+6 NaOH→2 Fe₂O₃+6 Na+3 H₂, endothermic at 500° C.

Fe₂O₃+3 CO→2 Fe+3 CO₂,

the carbon dioxide being regenerated to give carbon monoxide by high-temperature electrolysis.

Iron, sodium hydroxide and carbon monoxide are recovered from the electrodes.

The regenerator can comprise a device for the regeneration of an alloy to give metals by heat, in particular as indicated, for example, in the patent U.S. Pat. No. 3,245,836. The sodium-potassium alloy can be heated preferably above 578°° C., a temperature above which the alloys between the two metals disappear to leave room only for the two metals.

One of the reactions can be the reduction by carbon.

### High-temperature Electrolysis of Carbon Monoxide

One of the reactions can be the reduction of carbon dioxide to give carbon monoxide by high-temperature electrolysis:

CO₂->CO+½O₂.

The carbon dioxide can be converted into carbon monoxide, for example at 750°° C., by a high-temperature electrolyser, the electrolyte of which is a conductor of O²⁻ions. The electrolyte can be formed, for example, of a thick layer of 150 μm of 10Sc1CeSZ (ZrO₂ doped with 10% of the molecules as Sc₂O₃ molecules and 1% of the molecules as CeO₂ molecules). Each face of the electrolyte can be covered with a thick layer of 35-50 μm of porous GDC (ceria-doped gadolinium) which, on the side of the exit of the oxygen, can be infiltrated by a solution of 3 moles/l of cerium and praseodymium (with a molar ratio of 8 molecules of cerium per two molecules of praseodymium) and, on the side of the carbon dioxide and monoxide, can be infiltrated with a 3 moles/l solution of cerium and gadolinium nitrates in a Ce:Gd proportion of 8 per 2. The electrodes can be formed for one, for example, of thin strips of platinum or nickel with a thickness of 180 nm spaced apart by 10 μm, adhering to the GDC layers by means of platinum pastes. Alternatively, the high-temperature electrolyser can be of the Ny-YSZ or Ni-SDC type.

A voltage of between 1 and 2 V, preferably 1.19 V, can be applied to the electrodes, the-terminal being connected to the electrode joined to the face over which the carbon dioxide and the carbon monoxide flow. The flow can for example take place under a pressure of 1 atmosphere, preferably in laminar flow.

All or a portion of the electricity of the electrolysis can be provided by the cell.

### High-temperature Electrolysis of Metal Sulfide

One of the reactions can be the reduction of the metal sulfide by high-temperature electrolysis, using an electrolyte which conducts metal ions, such as β-alumina, according to the reaction:

MₓS->x M+S

at a temperature at which the metal sulfide is liquid.

Use may be made of electrically conductive electrodes, such as platinum or carbon, metal in the gaseous or preferably liquid form being released at one of the electrodes, while gaseous sulfur is released at the other electrode.

The cell is preferably fed with current by the electricity being released from another metal sulfide cell operating at a lower temperature but where the sulfur and the metal are both liquid. The difference in voltage between the operating voltages of the two cells can advantageously be used to feed an external apparatus with electric current and the metal and the sulfur which are extracted from the regeneration device can preferably be cooled countercurrentwise to the metal sulfide going to regeneration.

The metals M are, for example, potassium, lithium (for the latter two, the reaction is M₂S->2 M+S) or lead (for the latter, the reaction is MS->M+S). The cells can operate, for example, respectively at 120° C., 180° C. and 330° C. and the regeneration temperatures can, for example, be 850° C., 950° C. and 1150° C.

The metal can be sodium and the regeneration temperature can, for example, be 1177° C. or more. The reaction can be written:

2 Na+S->Na₂S.

### Storage

At least one of the products of the reaction at at least one of the electrodes can be stored in a tank with a view to its subsequent processing, in particular when the latter is not carried out continuously. This product of the reaction can be stored mixed or not with the reacting product.

The product stored in the tank can be cooled beforehand, in particular countercurrentwise to the product reaching the electrode, so as to heat the latter so as to ensure its melting or the maintenance of its liquid state at the electrode.

The product intended to be stored in the tank can be formed into small-sized noncontinuous elements which are easy to handle, for example formed into beads, before solidifying and then be conditioned in this form in the tank.

For example, manganite extracted from water can be stored in the form of a powder.

The product(s) resulting from the separation or from the chemical regeneration can be stored as described above or be reintroduced after the treatment has been carried out as liquid metal, liquid metal hydroxide or liquid metal oxide electrode.

### Operating Temperature

The operating temperature of the cell is chosen as a function of the materials of which it is made. It can in particular be between 280°° C. and 1100° C.

The operating temperature of the cell can be different from the temperature or temperatures of the chemical regeneration reactions. The temperature of the cell depends on the metals, oxides and hydroxides used and in particular on their melting points. It is chosen within the operating range of the temperature of the electrolyte and above the temperature of one of its metals, oxides or hydroxides chosen in order to be in the liquid state. The operating temperature of the electrolyte is sometimes influenced by the partial water pressure of the atmosphere surrounding said electrolyte, in particular in the case of the solid electrolyte of solid acid type, which is cesium dihydrogen phosphate.

### Use of Carbon at the Cathode

When the cathode comprises manganese dioxide MnO₂, which may or may not be mixed with carbon molecules. The mixing of manganese dioxide MnO₂ with carbon molecules can make it possible to increase the electrical conductivity of the cathode.

### Heat Source

The heat necessary for the regeneration of the electrodes and/or oxidizers and fuels of the cell can be provided by the combustion of a fuel, such as hydrogen, gasoline, diesel, biodiesel, ethanol burning in air or preferably in oxygen, for example extracted from the air by a zeolite filtration system.

The efficiency of the conversion of thermal energy into electrical energy can be improved thereby, for example of the order of a multiple of three compared with a heat engine. In addition, it is thus possible to avoid the formation of NOₓ, depending on the fuel and the oxidizer generating the heat necessary for the regeneration reactions, in particular if these do not contain nitrogen, such as hydrogen, alcohol or biodiesel, the oxidizer being, for example, oxygen extracted from the air using a zeolite filter. The efficiency of conversion of the chemical energy of hydrogen into electrical energy can thus be improved by approximately 50% in comparison with a conventional hydrogen fuel cell.

The heat can originate, for example, from a solar furnace, or from the depths of the earth if a sufficiently deep well is dug and the heat is extracted therefrom or else if the regeneration device is placed therein, in whole or in part.

The heat can also originate from fossil energy, from biofuels, such as wood or straw, or from the combustion of household waste.

The heat can originate from nuclear energy, including accelerated ion fusion nuclear energy, a portion of the electrical energy produced by the cell then advantageously being used for the production and the acceleration of said ions.

### EXAMPLES

### Example 1

Production of electricity by decomposition of oxygen at the cathode and oxidation of liquid zinc at the anode, the cathode being made of lanthanum strontium manganite, the electrolyte being made of yttria-stabilized zirconia (YSZ), for example with a thickness of 10 μm.

The cell operates, for example, at 830° C. and the heat released by the cell, added to the external heat, is used to manufacture hydrogen by the sulfur-iodine cycle, the temperature of 1000° C. necessary for the hydrogenation of the zinc oxide being provided by the external heat. It is estimated that 93.5% of the heat originating from the outside can thus be converted into electrical energy.

By using zinc as metal, the following reaction consuming molecular hydrogen can make it possible to regenerate the zinc oxide to give zinc: ZnO+H₂->Zn+H₂O

This reaction can take place at approximately 1000° C. in an 87% molecular nitrogen and 13% hydrogen mixture. It can also advantageously take place without molecular nitrogen and preferably in the absence of water.

In an alternative form, the reaction for the hydrogenation of the zinc oxide above can be used, by using, for heat, the energy released by the combustion of hydrogen in the air or by the combustion with molecular oxygen advantageously extracted from the air by zeolite. This option can be advantageous in order to avoid the formation of nitrogen oxides. The heat which is released from the fuel cell can also be recycled for the reaction for the hydrogenation of the zinc oxide or for the oxidation of the manganite.

In a further alternative form, the reaction for the hydrogenation of the zinc oxide above can be carried out by using hydrogen resulting from a process for the production of hydrogen by the sulfur-iodine cycle, or also by an oxide-cerium cycle. The sulfur-iodine cycle can make it possible, using high heat, to produce hydrogen while letting go a little heat at 120° C. for a heat energy loss estimated at approximately 15%. This is because the reaction I₂+SO₂+2H₂O→2 HI+H₂SO₄ can release 15% of the heat necessary for the two endothermic reactions:

2H₂SO₄→2SO₂+2H₂O+O₂ and 2 HI→I₂+H₂.

Alternatively, the zinc oxide can be reduced with the external heat to give metallic zinc at high temperature, in particular above 1727° C. The molecular oxygen can be separated from the zinc, for example by bringing the gas mixture to a pressure such that the partial gaseous zinc pressure reaches the pressure at which said gaseous zinc becomes liquid, i.e. approximately 30 GPa. Thus, the efficiency of conversion of the heat into electricity can be equal to the efficiency of said fuel cell.

Alternatively again, the zinc can be regenerated by reduction with carbon at a temperature of between 1280° C. and 1320° C. or with carbon monoxide at approximately 950° C., both reactions being endothermic and producing zinc and carbon dioxide, the carbon dioxide being regenerated to give carbon monoxide by high-temperature electrolysis, which itself can be converted into carbon and carbon dioxide by an exothermic reaction:

2 CO->C+CO₂ at 1 atm.

If the regeneration is done by carbon monoxide itself regenerated by high-temperature electrolysis, the share of the electricity supplied to the electrolysis of the regeneration in the total chemical energy supplied to the regeneration of the electrodes is, according to the calculations of the inventor, approximately 34%. Alternatively again, the heat can originate, for example, from a solar furnace, or from the depths of the earth if a sufficiently deep well is dug and the heat is extracted therefrom or else if the regeneration device is placed therein, in whole or in part, from fossil energy, or from biofuels, such as wood or straw, or from the combustion of household waste, or also from nuclear energy, including accelerated ion fusion nuclear energy, a portion of the electrical energy produced then advantageously being used for the production and the acceleration of said ions.

### Example 2

Production of electricity by decomposition of water at the cathode and oxidation of liquid zinc at the anode, the cathode being made of manganese dioxide MnO₂ and the electrolyte being made of cesium dihydrogen phosphate CsH₂PO₄, for example with a thickness of 10 μm. The cell operates, for example, at 440° C. For the regeneration of the electrodes, the zinc hydroxide is transformed into zinc oxide, for example at 80° C. or higher, which is itself reduced to metal at high temperature, for example of greater than 1727° C., with the external heat. The manganite formed by the reduction of the manganese dioxide is transformed into manganese dioxide by oxidation, the heat being supplied by the heat released by the operation of the cell and external heat. The efficiency of conversion of the heat into electricity can thus be close to 1, if the heat released by the cell does not exceed the heat absorbed by the manganite.

### Example 3

Production of electricity by decomposition of water at the cathode and oxidation of liquid rubidium at the anode, the cathode being made of manganese dioxide MnO₂ and the electrolyte being cesium dihydrogen phosphate CsH₂PO₄ (a solid acid), for example with a thickness of 10 μm. The cell operates, for example, at 300° C. For the regeneration, the rubidium hydroxide is reduced to rubidium oxide at 90° C., which is itself transformed into rubidium by oxidation with magnesium, the magnesium oxide being reduced to magnesium by the Pidgeon reaction, the carbon monoxide being subsequently transformed into carbon and carbon dioxide, then the carbon dioxide being transformed into carbon monoxide by high-temperature electrolysis. The manganite formed by the reduction of the manganese dioxide is transformed into manganese dioxide by oxidation at 300°° C., the heat being supplied by the heat released by the operation of the cell and the transformation of the carbon monoxide into carbon and external heat. The efficiency of conversion of the heat into electricity can thus be close to 1, if the heat released by the cell does not exceed the heat absorbed by the manganite.

### Example 4

Production of electricity by decomposition of water at the cathode and oxidation of liquid rubidium at the anode, the cathode being, for example, carbon impregnated with platinum nanoparticles and the electrolyte being Nafion (registered brandname), which is a proton exchange membrane. The cell operates, for example, at 100° C. For the regeneration, the rubidium hydroxide is reduced to rubidium oxide at 90° C., which is itself transformed into rubidium by oxidation with magnesium, the magnesium oxide being reduced to magnesium by example the Pidgeon reaction, the carbon monoxide being, for example, subsequently transformed into carbon and carbon dioxide by exothermic reactions. Thus, the efficiency of conversion of the heat into electricity can be higher than the efficiency of said fuel cell, all or a portion of the heat released from the cell at 100° C. and the conversion of the carbon monoxide into carbon and carbon dioxide being used for the transformation of the rubidium hydroxide into rubidium oxide.

### Circulation of the Liquid Electrodes

The liquid metal, liquid metal oxide or liquid metal hydroxide can circulate in millifluidic channels, preferably with a depth of 1 mm, a width of 2 mm and spaced 0.5 mm apart, for example made of silicon dioxide, one of the faces being covered with a membrane or membranes acting as electrolyte, or preferably made of a material which is a good electrical conductor, such as carbon or stainless steel, in particular if the liquid is a poor electrical conductor, such as a metal oxide, a metal hydroxide or sulfur; the surface of the material in which the channels are inscribed can then advantageously be covered with an electrical insulator in its part in contact with the electrolyte.

The millifluidic channels can be used for heat exchanges, in particular countercurrentwise heat exchanges.

The metal in the molten state can be obtained from metal ingots which are melted, for example with the same heat source as that used for the regeneration of the electrodes.

Another subject matter of the invention, independently of or in combination with the foregoing, is a device for the production of electricity comprising a fuel cell or a fuel cell system as described above and a system for regeneration of a metal oxide produced at the anode to give metal.

The regenerated metal can be used to feed the anode with metal in the molten state.

The device can comprise a centrifuge in order to extract the metal oxide from the metal in the molten state of the anode.

Another subject matter of the invention, independently of or in combination with the foregoing, is a process for the production of electricity, in particular by means of a fuel cell or of a fuel cell system as described above, in which a metal oxide is produced at the anode, which anode comprises a metal in the molten state.

The metal oxide produced at the anode can be discharged by the circulation of the metal in the molten state.

The metal oxide can be separated from the nonoxidized metal in the molten state by settling or centrifugation.

The centrifugation can take place in a centrifuge, from the center of which the metal oxide is extracted, if it is less dense than the metal itself, and the metal of which is also extracted at the other end.

The metal oxide produced can subsequently be regenerated to give metal, as described in detail above.

### Complete Cycles

Another subject matter of the invention, independently of or in combination with the foregoing, is a process which makes it possible to produce electricity by decomposition of oxygen at the cathode and oxidation of liquid zinc at the anode, the cathode being made of lanthanum strontium manganite and the electrolyte being made of yttria-stabilized zirconia (YSZ) with a thickness of 10 um, which is a solid oxide. The cell operates at 830° C. and the heat released by the cell, added to the external heat, is used to manufacture hydrogen by the sulfur-iodine cycle, the heat at 1100° C. necessary for the hydrogenation of the zinc oxide being provided by the external heat. According to the calculations of the inventor, 89% of the heat originating from the outside can thus be converted into electrical energy.

Another subject matter of the invention, independently of or in combination with the foregoing, is a process which makes it possible to produce electricity by decomposition of oxygen at the cathode and oxidation of liquid zinc at the anode, the cathode being made of lanthanum strontium manganite and the electrolyte being made of yttria-stabilized zirconia (YSZ) with a thickness of 10 μm, which is a solid oxide. The cell operates, for example, at 880° C. The zinc oxide is reduced to metallic zinc at 1727°° C. with the external heat. Thus, the efficiency of conversion of the heat into electricity can be equal to the efficiency of said fuel cell.

Another subject matter of the invention, independently of or in combination with the foregoing, is a process which makes it possible to produce electricity by decomposition of water at the cathode and hydroxylation of liquid sodium at the anode, the cathode being made of manganese dioxide MnO₂ and the electrolyte being made of LDPE-BTMA with a thickness of 55 μm, which is an anion exchange membrane. The cell operates, for example, at 100° C. For the regeneration, the sodium hydroxide is transformed into sodium and iron (III) oxide at 500° C., the iron (III) oxide being reduced to iron and carbon dioxide by carbon monoxide, the carbon dioxide being oxidized by high-temperature electrolysis. The manganite formed by the reduction of the manganese dioxide is transformed into manganese dioxide by oxidation with oxygen at 300° C. by virtue of the heat supplied from the release of heat by the operation of the cell and/or external heat. The efficiency of conversion of the heat into electricity can thus be close to 1, if the heat released by the cell does not exceed the heat absorbed by the manganite.

Another subject matter of the invention, independently of or in combination with the foregoing, is a process which makes it possible to produce electricity by decomposition of oxygen at the cathode and oxidation of liquid rubidium at the anode, the cathode being made of lanthanum strontium manganite and the electrolyte being GDC-ESB with a thickness of 10 μm, which is a solid oxide electrolyte. The cell operates, for example, at 500° C. For the regeneration, the rubidium oxide is reduced to rubidium by oxidation with magnesium, the magnesium oxide being reduced to magnesium by carbonization at, for example, 2300° C., the carbon monoxide being subsequently transformed into carbon and molecular oxygen by endothermic high-temperature electrolysis reactions.

### Uses

Another subject matter of the invention, independently of or in combination with the foregoing, is the use of the fuel cell or of the fuel cell system as described above.

The cell according to the invention can in particular make it possible to produce electricity for a vehicle, a dwelling, an industry or a community.

The fuel cell according to the invention can be used to produce electric current, for example for industrial use, for domestic use, for vehicles, or for energy production devices, in particular electrical ones, requiring high electrical power to operate. This can concern, for example, accelerated ion nuclear fusion or the electrolysis of alumina.

The heat released by the cell can be used to create hydrogen, in particular by the iodine-sulfur cycle, which can be advantageously used for the regeneration of the metal oxide to give metal.

Another subject matter of the invention, independently of or in combination with the foregoing, is the use of the fuel cell or of the fuel cell system as described above, the heat being provided by:
the combustion of a fuel, such as hydrogen, gasoline, diesel, biodiesel, ethanol burning in air or preferably in oxygen, for example extracted from the air by a zeolite filtration system, or
a solar furnace, or depths of the earth if a sufficiently deep well is dug and the heat is extracted therefrom or else if the regenerator is placed therein, in whole or in part,
the combustion of fossil energy, or of biofuels, such as wood or straw, or combustion of household waste,
nuclear energy, in particular accelerated ion fusion nuclear energy, a portion of the electrical energy produced preferably being used for the production and the acceleration of said ions.

It can also make it possible to produce electricity to feed or cofeed energy to a device for fusion or for production of neutrons by accelerated ions, in particular in order to accelerate ions for the purpose of a fusion nuclear reaction.

The heat which is released from the fuel cell can also be recycled for one or more of the abovementioned reactions but also for, possibly, the oxidation of the manganite.

### BRIEF DESCRIPTION OF THE DRAWINGS

FIG. 1 diagrammatically and partially represents an example of a system according to the invention.

FIG. 2 diagrammatically and partially represents another example of a system according to the invention.

FIG. 3 diagrammatically and partially represents another example of a system according to the invention.

### DETAILED DESCRIPTION

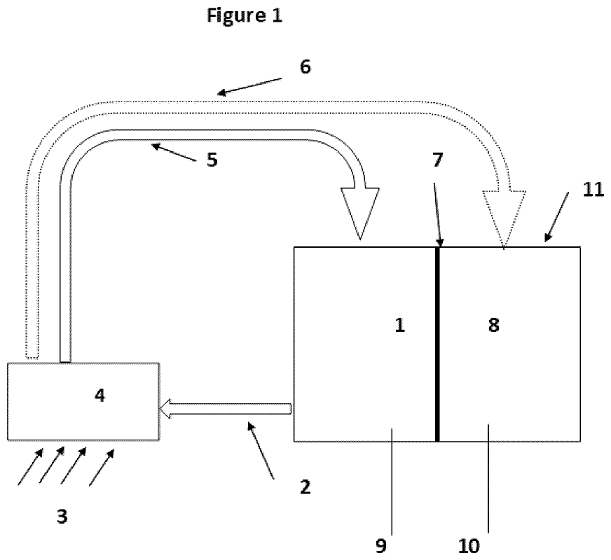

There has been illustrated, in FIG. 1, an example of a cell system 11 according to the invention.

The cell system comprises a battery having electrodes 1 and 8 connected to respective electrical terminals 9 and 10. The electrodes 1 and 8 have the form of compartments.

The electrodes 1 and 8 are separated by a solid electrolyte 7.

The electrode 1 consists of a metal or a metal oxide in the liquid state and is recycled in a regenerator 4 where it is regenerated by the supply of heat 3 and then reinjected into the electrode 1 compartment of the cell.

The electrode 8 or else the fuel supplied to the electrode 8 is ionized by the electrons supplied or withdrawn by the terminal 10 of the cell 11. In addition, the ions pass through the solid electrolyte 7 to cause the liquid electrode 1 to react in combination with the electrons withdrawn or supplied by the terminal 9.

The cell 11, the electrode 1 of which comprises a metal or a metal oxide in the liquid state, is recycled in the chemical reactor(s) 4 by the supply of heat 3, then reinjected via the pipe 5 into the container of the liquid electrode 1.

A portion of the regeneration product, for example the metal or the oxygen corresponding to the ions which have passed through the electrolyte 7, can be reintroduced into the compartment of the electrode 8 via a pipe 6.

In one example, the anode is formed of molten zinc, which circulates in a circuit which ensures, on the one hand, the supply of metal as it is consumed and, on the other hand, the extraction of the oxide.

The cell can also make possible the transformation of the oxide into metal, continuously, or, in an alternative form, this transformation is carried out noncontinuously.

The electrolyte is a solid oxide, for example lanthanum strontium cobalt ferrite, advantageously separated from the molten metal by a layer of ceria, this electrolyte allowing the passage of the O²⁻ions which oxidize the metal, said O²⁻ions originating from the separation of molecular oxygen by supply of electrons to the cathode of the cell. This cathode consists, for example, of lanthanum strontium manganite, fed with oxygen originating from, for example, the ambient air or the oxygen-enriched air of a zeolite concentrator, or from the regeneration of the metal oxide to give metal.

The reaction at the anode is:

M+O⁻->MO+e⁻

and the reaction at the cathode is:

½O₂+2 e⁻->O²⁻

where M is the metal, for example zinc Zn.

The regenerator separates the zinc from the oxide formed. This regenerator can comprise a centrifuge for extracting the zinc oxide from the molten zinc, which circulates to the anode.

The oxide can be stored pending its reduction to metal. The zinc freed from the oxide can be returned to the anode.

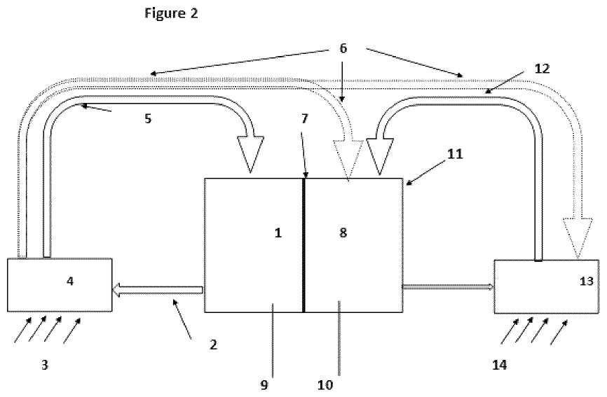

An alternative form, where the two electrodes 1 and 8 are regenerated by different chemical reactions, will now be described with reference to FIG. 2.

In this FIG. 2, the second electrode 8 comprises a molten metal or metal oxide, such as magnesium dioxide MnO₂. This electrode 8 is also regenerated thermally by heat 14 in one or more reactors 13. A product from the regeneration of the electrode 1 can be reinjected into the compartment of the electrode 8 via a pipe 12, or into the regenerator 13 of the electrode 8.

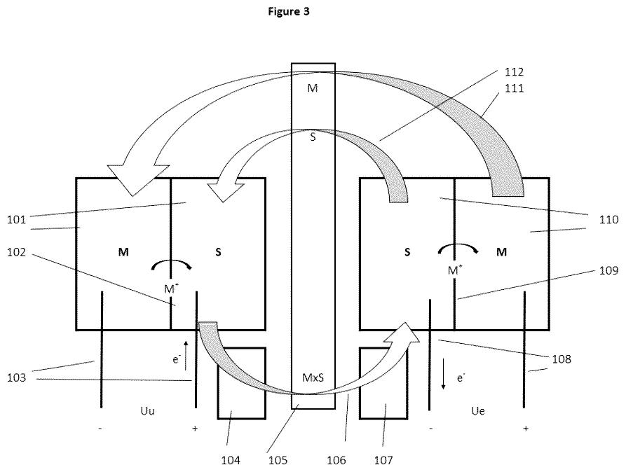

An alternative embodiment operating with liquid sulfur and producing a metal sulfide will now be described with reference to FIG. 3.

The compartments 101 of the system respectively contain the liquid metal and the liquid sulfur separated by a solid electrolyte 102. The metal ions M⁺ or M⁺⁺ migrate through the electrolyte 102 to produce a current at the terminals of the electrodes 103. The solid metal sulfide MₓS formed following the oxidation of the metal is extracted by a filter, a centrifuge or a settler 104, then heated in the heat exchanger 105 and then in the heating device 107 to which external energy is supplied. The metal sulfide MₓS is thus brought to the temperature used for its transformation by electrolysis in the compartments of the regenerator 110 which are separated by an electrolyte 109. A regeneration voltage is applied to the electrodes 108 of the regenerator 110.

The regenerated metal M, preferably in liquid form, is transferred via the pipe 111 to the metal compartment of the compartments 101 of the system, while being cooled in the heat exchanger 105.

The regenerated sulfur S, preferably in gaseous form, is transferred via the pipe 112 to the sulfur compartment of the compartments 101 of the system while passing through the heat exchanger 105, in which it is cooled and liquefied.

1. An electrochemical reaction fuel cell system, comprising:
a cathode,
an anode,
one at least of the anode and of the cathode comprising at least one metal, one metal hydroxide or one metal oxide in the molten state,
a solid electrolyte, placed between the cathode and the anode,
at least one regenerator for regenerating, starting from one at least of the oxidation-reduction reaction products which is recovered at at least one of the anode and of the cathode, by a reaction, at least one of the products constituting at least one of the anode or of the cathode or the fuel or oxidizer consumed at at least one of the anode or of the cathode, one of the regeneration products being reintroduced into the system as electrode made of liquid metal or liquid metal oxide or in the form of fuel or oxidizer, one of the reactions making possible said regeneration or making possible the regeneration of one of the reactants of the oxidation-reduction reaction being endothermic.

2. The cell system as claimed in claim 1, the anode comprising a metal in the molten state.

3. The cell system as claimed in claim 1, the cathode comprising a metal oxide in the molten state.

4. The fuel cell system as claimed in claim 3, the molten metal being chosen from the following list: zinc, lithium, magnesium, aluminum, lead, sodium, cesium, rubidium, copper and tin.

5. The fuel cell system as claimed in claim 1, being configured to produce or consume, at the anode or at the cathode, a metal oxide or a metal hydroxide chosen from the following list: zinc oxide (ZnO), lithium oxide (Li₂O), magnesium oxide (MgO), alumina (Al₂O₃), lead oxide (PbO), lead dioxide (PbO₂), sodium oxide (Na₂O), cesium oxide (Cs₂O), rubidium oxide (Rb₂O), copper (II) oxide (CuO), copper (I) oxide (Cu₂O), copper (III) oxide (Cu₂O₃), manganese dioxide (MnO₂), sodium hydroxide (NaOH), manganese hydroxide (MnOOH) and zinc hydroxide (Zn (OH)₂).

6. The cell system as claimed in claim 1, comprising a solid electrolyte chosen from:
(i) an O²⁻ion exchange membrane, or
(ii) a solid acid, or
(iii) an anion exchange membrane, or
(iv) a metal ion exchange membrane.

7. The cell system as claimed in claim 6, comprising a separating membrane between the anode and the electrolyte, the separating membrane being an O²⁻ion exchanger.

8. The system as claimed in claim 7, the separating membrane comprising ceria.

9. The fuel cell system as claimed in claim 7, comprising an electrolyte in the form of a solid oxide.

10. The fuel cell system as claimed in claim 7, being configured to operate at temperatures of 280° C. and 1100° C.

11. The fuel cell system as claimed in claim 9, the solid oxide being chosen from the following list:
yttria-stabilized zirconia, referred to as YSZ,
scandia-stabilized zirconia, referred to as ScSZ,
ceria-salt ceramic composites, referred to as CSCs,
erbia-cation-stabilized bismuth, referred to as ERB,
gadolinium-doped ceria, referred to as GDC,
samaria-doped ceria, referred to as SDC,
ceria/bismuth-oxide bilayered electrolyte, referred to as GDC-ESB, formed of a layer of ceria-doped gadolinium and of a layer of erbia-stabilized bismuth oxide,
strontium iron oxide SrFeO₂,
and their mixtures.

12. The fuel cell system as claimed in claim 1, the O²⁻ions originating from the separation of molecular oxygen by supplying electrons to the electrode of the cell which absorbs molecular oxygen.

13. The fuel cell system as claimed in claim 1, the metal, the metal hydroxide or the metal oxide consumed at the anode and/or at the cathode originating from at least one reserve.

14. The cell system as claimed in claim 13, one of said reserves being in solid form.

15. The cell system as claimed in claim 1, the or one of the products of the chemical reaction at at least one of the electrodes being separated from the reacting product.

16. The cell system as claimed in claim 15, the separation being carried out by static or nonstatic settling or by centrifugation.

17. The cell system as claimed in claim 1, one of the reactions making possible the regeneration of one of the reactants of the oxidation-reduction reaction being endothermic.

18. The system as claimed in claim 1, all or a portion of the electricity of the electrolysis being provided by the cell.

19. The cell system as claimed in claim 1, wherein said cell system is configured to produce electricity for a vehicle, a dwelling, an industry or a community, and/or for producing electricity to feed or cofeed energy to a device for fusion or for production of neutrons by accelerated ions.

20. The cell system as claimed in claim 19, wherein the heat which is released from the fuel cell is recycled for one or more of the abovementioned reactions but also for, optionally, the oxidation of the manganite.

21. The cell system as claimed in claim 14, one of said reserves being in the form of beads, said beads being melted in order to be introduced in the liquid state at said electrode.
